(19) United States
(12) Patent Application Publication
(10) Pub. No.: US 2014/0046948 A1
(43) Pub. Date: Feb. 13, 2014

(54) DATABASE SYSTEM AND METHOD

(71) Applicant: Navino Evans, London (GB)

(72) Inventor: Navino Evans, London (GB)

(21) Appl. No.: 13/961,016

(22) Filed: Aug. 7, 2013

(30) Foreign Application Priority Data
Aug. 9, 2012 (GB) GB1214259.2

(51) Int. Cl. G06F 17/30

(52) U.S. Cl. CPC G06F 17/30867
USPC 707/740

(57) ABSTRACT

A system and method are disclosed wherein a data collection server performs a database dump to a network server. The dumped database provides some item subject identification data, such as place and date, but need not contain any. A scanning program checks through the dumped database items seeking for other filtering information and saving that information with the database item in association with which it was discovered to provide an improved database. A user can select one or more subject categories from the improved database and select filters to refine down what Items are displayed in a timeline 94 according to filter categorized. The user can manipulate, introduce and change items within a timeline to the user's choice. The user can communicate their selection to others.

### CROSS-REFERENCE TO RELATED APPLICATION

This application claims the benefit of U.K. Patent Application No. GB1214259.2, filed Aug. 9, 2012, the entire disclosure of which is incorporated herein by reference.

### FIELD OF THE INVENTION

The present invention relates to a system and method for discovering and organizing chronology, otherwise known as a timeline, for accessible web server sites where a downloadable database is provided.

### BACKGROUND OF THE INVENTION

The present invention is described as relating to the web accessible Wikipedia site. It is to be realized that the present invention can be used on any accessible website having the same or similar characteristics and properties as Wikipedia.

The website Wikipedia is well known as a contributor created encyclopaedic database that can be freely accessed by any web user by simply searching a subject heading or headings.

### The Prior Art

Wikipedia itself only allows one heading to be searched at a time. Some searches require a plural header search to give a complete picture. There is currently no web searchable resource allowing the results of multiple search headings to be made available together to a user.

Many subject areas will differ in user contributed portions depending upon the time of contribution or time of event. Currently, there is no web searchable source capable of making a chronology of contributions.

Many subject areas will differ in user contributed portions depending upon the place from which a contribution was made or place of event. Currently, there is no web searchable source capable of making a geography of contributions.

There exists a web resource called Chronozoom that attempts to create a timeline covering all of history from the alleged big bang to the present day.

Chronozoom is an independent facility, not sourced from Wikipedia or any other facility, and is reliant, like Wikipedia, on people adding new content directly to their site. Chronozoom, being a history site, thus does not offer the wide range of subjects to be founds on Wikipedia. The present invention seeks to provide a full subject range facility.

In Chronozoom, there is no way of filtering the content on the timeline by subject or location. Equally, there is no way of displaying multiple time lines to compare events, and there is no system for stacking events by popularity. The present invention seeks to improve there over by providing a solution to these limitations.

Retrieved material from any web site often carries copyright burdens. An image, video, table or text, to name but a few possible copyright items, can be provided by the user accessed website, with copyright permission from the original copyright holder, to be experienced and used by the website user, but not otherwise passed on or disseminated by the website user or used in business or commerce. Nearly all websites fail to make evident to a website user what material is subject to copyright restrictions and what material is not. This could be critical in a knowledge based website where material could be acquired, for example, for lessons, lectures and content of other websites. The present invention seeks to provide to the user indication of whether or not any selected item is available free of some or all copyright restrictions.

### SUMMARY OF THE INVENTION

According to a first aspect, the invention provides a system operable to allow a user to access and filter a database, the system comprising

communication means operable to receive a downloaded database dump from a data collection server;

scanning means operable to scan the downloaded database dump to discover and mark content falling into any one of a plurality of filtering categories;

improved database storage means operable to store the marked database as an improved database;

user interface means operable to permit a user to access the improved database to obtain and display one or more subject categories on a timeline;

where

the user interface is operable to permit filtering of the displayed one or more subject categories.

According to a second aspect, the present invention provides a method for allowing a user to access and filter a database, the method comprising:

a step of receiving a downloaded database dump from a data collection server;

a step of scanning the downloaded database dump to discover and mark content falling into any one a plurality of filtering categories;

a step of storing the marked database as an improved database;

and

a step of permitting a user to access the improved database to obtain and display one or more subject categories on a timeline;

where

the a step of permitting a user to access the improved database includes a step of permitting the user to filter the displayed one or more subject categories.

The invention further provides that a user can perform at least one of: adding own items to a displayed timeline; removing items from a displayed timeline; scrolling a displayed timeline; and rearranging a displayed timeline.

The invention further provides that the subject categories can include at least one of: subject title; and place.

The invention further provides that the filtering categories, non exhaustively, can include at least one of: items containing copyright prohibited material; items containing copyright free material; subject matter; items containing audio material; items containing photographic material; items containing video material; date of birth; date of death, date of construction; date of release; date of discovery; date of event; person's name; place of event; and place of image.

It is to be understood that the invention is capable of adopting any category for filtering, other than the ones indicated. It is preferred that a user can enter any term for that term to be used for filtering.

The invention further provides that the user to is able to store a displayed assembly of data from the improved database.

The invention further provides that the user can send to others the displayed assembled data from the improved database.

The invention further provides that the database dump can be a dump of the Wikipedia database.

It is to be understood. that the term “categories” also encompassed “locations”

### BRIEF DESCRIPTIONS OF THE DRAWINGS

The invention is described, by way of example, by the following description to be read in conjunction with the appended drawings, in which:

FIG. 1 shows an exemplary diagram of an environment wherein the invention can be employed.

FIG. 2 is a flowchart showing exemplary operation of the network server of FIG. 1 forming the basis whereby the service provided by the network server to the clients is derived.

FIG. 3 is a flow chart showing activities undertaken to service a user request as shown in FIG. 2.

FIG. 4 in an exemplary block diagram showing elements contained within the network server 12 of FIG. 1.

FIG. 5 shows an exemplary block diagram of the different software element used to implement the invention; and

FIG. 6 shows an exemplary screen layout of one possible GUI screen display suitable for use with the invention.

### DETAILED DESCRIPTION OF THE INVENTION

A network 10, such as the Internet, comprises a network server 12 providing two way data communication with one or more fixed user clients 14 in the form of network connected processors, such as, but not limited to, PCs, and laptop computers. The fixed user clients 14 also include WiFi connected devices.

Portable user clients 16 employing mobile or portable devices such as, but not limited to, Internet enabled 3G or 4G phones and tablets, are in two way radio communication with base stations 18 that can be two way data connected to the network server 12 using, for example, a phone gateway server 20, thereby allowing portable devices 16 also to be interactively connected with the network server 12.

Among many other sites within the network 10 is a data collection server 22, serving its own clients (not shown) with information in response to data subject requests. The data collection server 22 houses a collection of data that is added to from time to time. The data collection server 22, in the example here described, services and maintains the Wikipedia website. It is to be understood that the invention also encompasses any other site possessing the same qualities and properties as the Wikipedia site. The invention is described, hereafter, for use with the Wikipedia site.

The data collection server 22 is coupled to exchange communications the network server 12. AS will be described later, the data collection server 22 can provide data and database tables to the network server 12 and can, in turn, receive, for example new data potentially to be stored, input derived from network server 12 clients 14, 16.

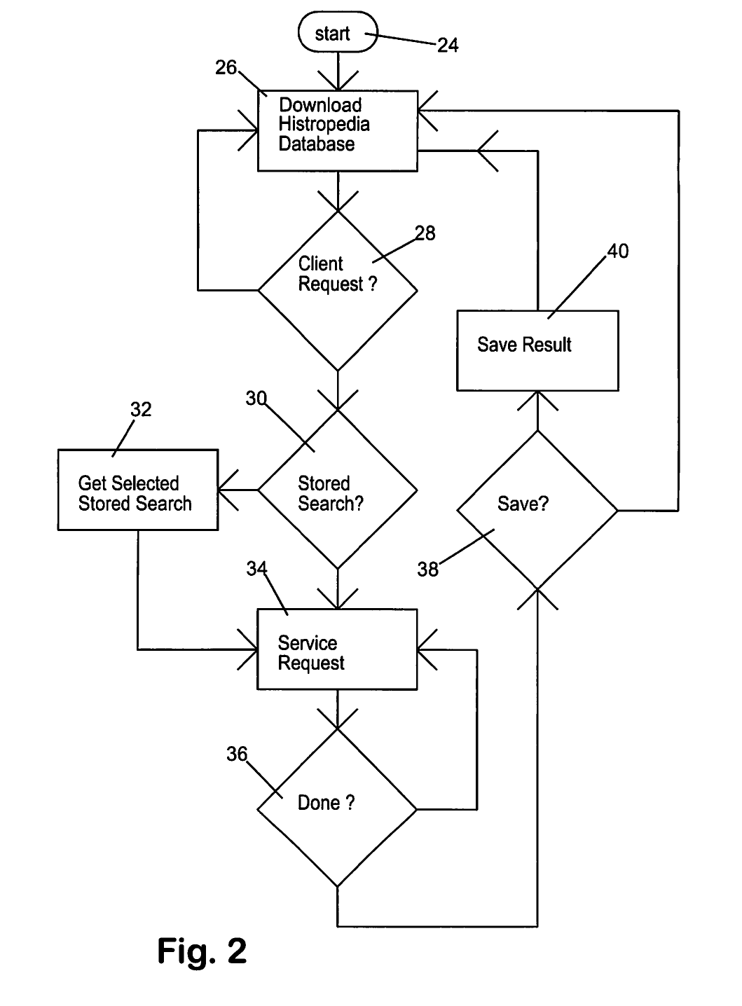

Attention is next drawn to FIG. 2, a flowchart showing exemplary operation of the network server 12 forming the basis whereby the service provided by the network server 12 to the clients 14, 16 is derived.

From a start 24, a first operation 26 has the network server 12 access the Wikipedia data collection server 22 and download all Wikipedia data in the form of a downloadable database dump. The Wikipedia database dump is made available to server operators for download. As later described, the Wikipedia database dump is searched and annotated in the network server 12 to become an improved database, here called the “Histropedia” database store and worked on in the network server 12.

The Histropedia database contains the entire Wikipedia sum of entries as provided by contributors to date, and lists, but is not limited to:
1. Item heading
2. Entry content.
3. Date of Contribution and/or date an event occurred.
4. Place where an event occurred.
5. Copyright status of each item of content.

In the normal way, if accessing Wikipedia directly, a user would specify to search an item heading, and receive a download, usually in reverse order of contribution, a download of the Wikipedia entry requested comprising a plurality of items of content.

However, none of items 2 to 4 above would be visible or available to the direct Wikipedia user.

If a first test 28 does not detect that a user 14, 16 requires access to the network server 12, the first operation 26 continues. If the first test 28 finds that a user 14, 16 needs access, a second test 30 checks to see if the user 14, 16 has previously made a search and stored the result. If the second test 30 finds that a previously stored search result has been stored and is required by that user 14, 16, a second operation 32 retrieves the stored results from a storage memory, presents the stored results to the user 14, 16, and passes control to a third operation 34. If the second test 30 finds that no stored result is needed, control is passed directly to the third operation 34.

The third operation 34 services the user request, in a many described here after, until a third test 36 finds that the user 14, 16 has finished his work and passes control to a fourth test 38 that finds whether or not the user 14, 16 desired to store the result for later retrieval. If not, control is passed directly to the first operation 26 to continue to download the Histropedia database. If the fourth test 38 finds that the user 14, 16 wishes to store the result, a fourth operation 40 stores the result before returning control to the first operation 26.

The flowchart of FIG. 2 is given only by way of an example. The processes shown in FIG. 2 may, within the invention, be implemented otherwise. Although FIG. 2 shows just one user 14, 16 being serviced at a time, it is to be appreciated that, in reality, plural users 14, 16 can have access simultaneously. It is also to be appreciated that the activity of the first operation 26 can be performed by a separate processor and downloaded results offered to the first test 28. It is also to be appreciated that the Histropedia database may be periodically downloaded or continuously downloaded. It is further to be appreciated that user 14, 16 can have direct access to the Wikipedia data collection server 22 for all or some of the items selected.

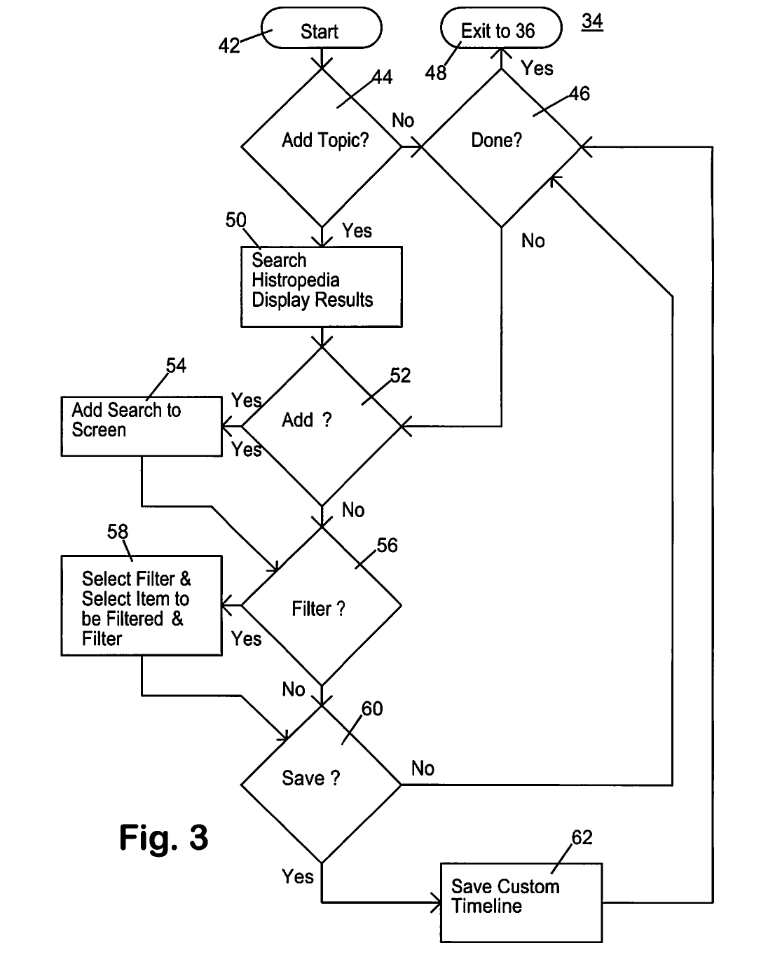

Attention is next drawn to FIG. 3, a flow chart showing activities undertaken to service a request as shown as the third operation 34 in FIG. 2.

The third operation 34 is started 42 by entry from the second test 30 or from the second operation 32. If from second operation 32 the user's stored timeline data has already been recovered, and if from the second test 30 a new timeline must be created. Either way, a forth test 44 checks to see if the user wishes to add a category to the user's custom timeline. If not a fifth test 46 checks whether or not the user is finished servicing the request and if so, passes control to an exit 48 to pass control onto the third test 36 of FIG. 2.

If the forth test 44 finds that the user wishes to add a new category, a fifth operation has the user enter the title of the new category, the Histropedia database is searched, and the titled entry found. The titled entry is displayed.

A sixth test 52 then checks to see if, after inspection of the content of the titled entry, the user wishes permanently to make the titled entry a permanent feature of the displayed custom timeline. If not, the titled entry is discarded. If so, a sixth operation 54 adds the titled entry to the displayed timeline. If the user had previously selected, in the second operation 32 of FIG. 2, a pre-existing stored custom timeline, the titled entry is added to the displayed custom timeline as a new related category. If the user had not previously selected a pre-existing stored custom timeline, the titled entry is added as a new custom timeline.

A seventh test 56 then seeks to discover whether or not the user wishes to filter the content of the displayed custom timeline. If the user wishes to apply a filter, a seventh operation 58 prompts the user to select one of the categories in the displayed custom timeline. As will later be explained and described, the user interfaces with the executed program by means of a Graphical User Interface (GUI). To select a category, the user can, for example, click upon the displayed category to select that category for filtering. If there is more than one category in the displayed custom timeline, an alternative allows the user to select two or more categorises for simultaneous filtering.

The seventh operation 58 then has the user select what filter the user wishes to apply. A filtered result limits the selected displayed timeline to elements that are included within the selected filter definition. As an alternative, the filtered result can be selected to exclude all elements that are excluded from the selected filter definition.

A selected filter definitions includes at least time. Time filter selection can include, for example, selection of elements occurring between start and end times, or elements occurring before a selected time, or elements occurring after a selected time, or lying within sets of selected times.

Another selected filter definitions includes at place. Place filter selection can include, for example, elements from a selected place, and elements from one or more selected places. The place selection can also be narrowed to specify smaller elements of a place, such as specified buildings, bridge, views or persons.

As another variant, the filter definitions can include at least one of:
a) Contains copyright prohibited material
b) Contains copyright free material.
c) Contains audio material
d) Contains photographic material
e) Contains video material.

It will be clear that the user, by repeatedly applying filtering operations, can create a selected category custom timeline with many different and varied outcomes according to the user's particular needs and desires.

The seventh operation 58, the user having selected the nature of the filter, then applies the filter to the selected displayed categories of the custom timeline and replaces the selected displayed custom timeline category or categories with the filtered result or results.

The seventh operation 58 also, for preference, allows selected filtering operations to be undone. The seventh operation 58 also, for preference, allows further filtering operations to be performed.

Upon completion of the seventh operation 58, or if the seventh test 56 did not detect that the user wished to apply a filtering operation, control is passed to an eighth test 60 which checks to see if the user is happy with the result and wishes to store the new custom timeline to be called up and displayed at a later time.

If the user wishes the result to be saved, an eighth operation 62 stores the result and passes control back to the fifth test 46. If the eighth test 62 finds that the user does not wish to save the result, it passes control directly to the fifth test 46.

The fifth test 46, if it finds that the user does not wish to exit the third operation 34 of FIG. 2, sends control to the sixth test 52 for possible category addition and/or filtering.

The processes shown in FIG. 3 are by way of example only, and may, within the invention, be implemented otherwise. FIG. 3 shows how a user can (reversibly) add and filter material to provide a custom timeline.

Not shown in FIG. 3 is the ability a user has to call up a custom timeline and publicly or privately share the selected custom timeline (or parts thereof) with another individual by data transmission. Such facilities are to be found on any Internet accessible site (such as, but not limited to, Twitter (trademark) or Facebook (trademark)) or by any other means of transmission such as “Dropbox” (trademark) or email.

When calling up material for sending to others, it is preferred that the copyright status of elements within the material to be provided to the user be made known. This can be done by, for example, use of “popup” flags, to name but one method. It is also preferred that copyright restricted material is automatically excised or blocked from what is being sent in response to a negative copyright notice contained in or in relation to the restricted material.

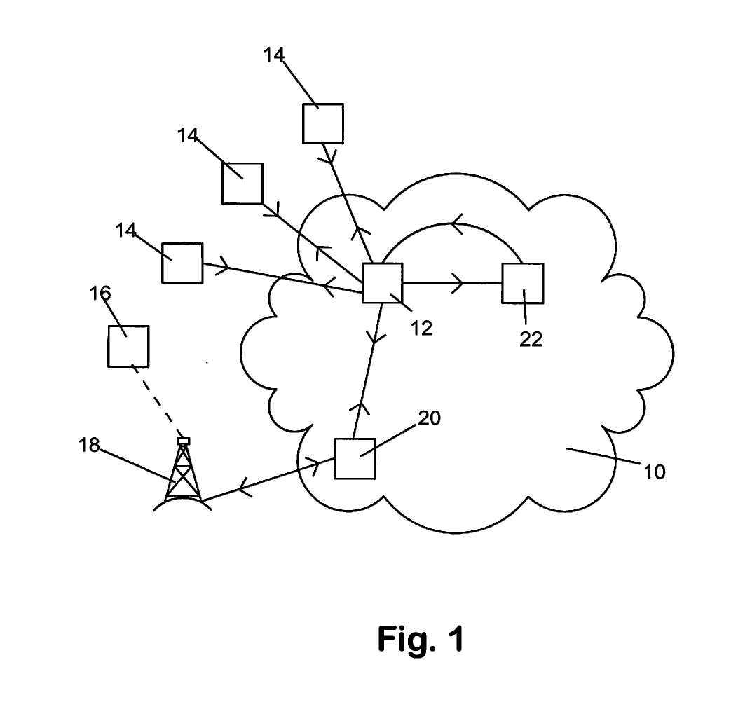

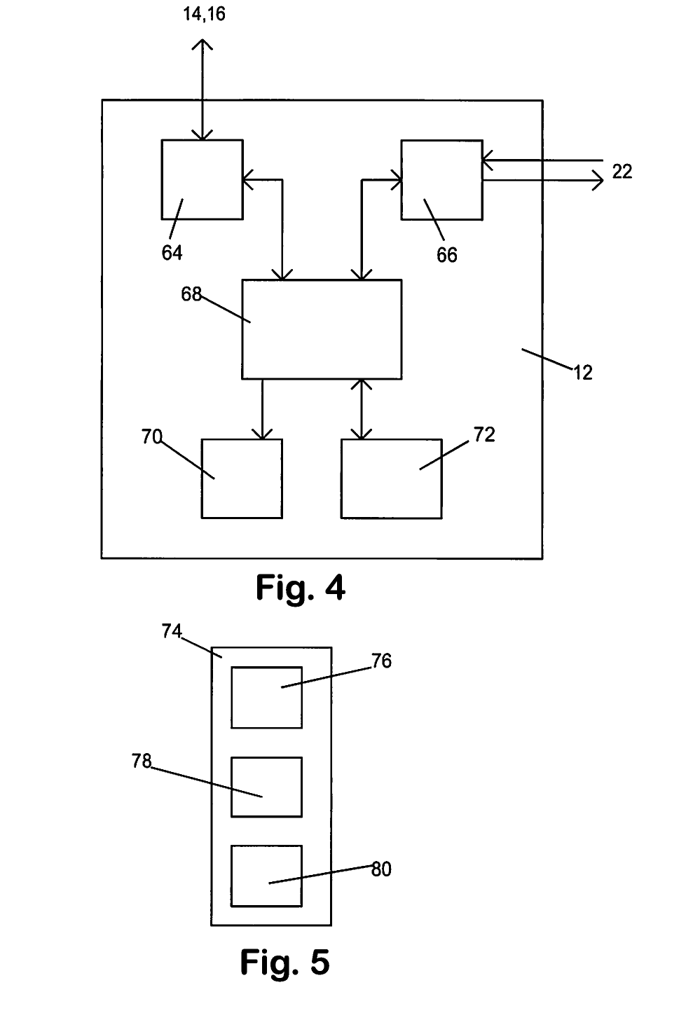

Attention is next drawn to FIG. 4, showing, by way of example, a block diagram of possible contents of the network server 12 shown in FIG. 1.

The network server 12 comprises user communication means such as a user modem 64 employed to communicate with the fixed 14 and portable 16 user clients. A data collection server modem 66 provides communication with the data collection server 22 of FIG. 1, in the example given the Wikipedia server. A network server processor 68 receives and sends data from the user modem 64 and the data collection server modem 66. User data is stored and retrieved by the processor 68 by a user memory 70 and database contents from the data collection server 22 is stored by the processor 68 in a database memory 72. The database memory 72 stores the improved Wikipedia database, that is, the Histropedia database.

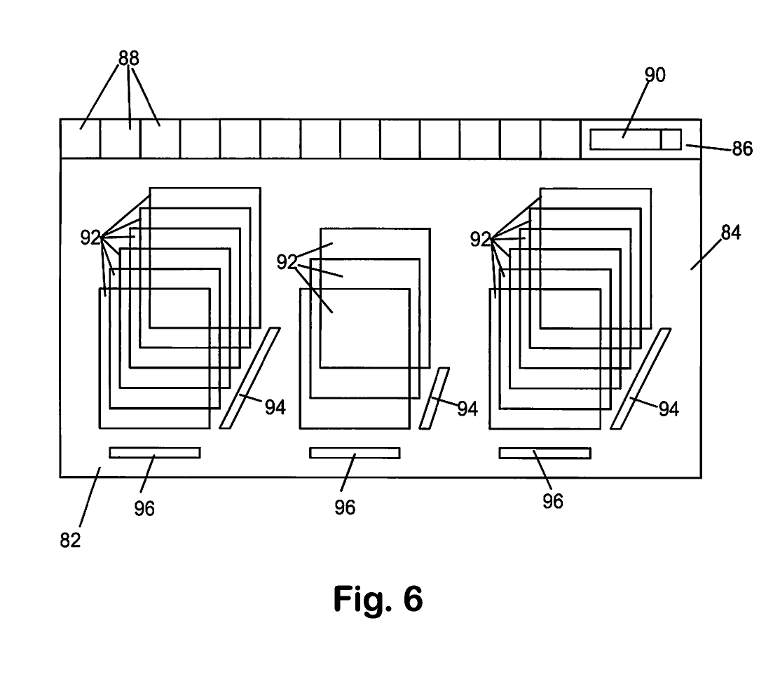

Attention is next drawn to FIG. 5 showing, by way of example, an exemplary block diagram of the different software element used to implement the invention.

The overall software 74 comprises a scanning program 76, an automated program that analyses the most recent Wikipedia ‘data dump’ file to extract key information about each event (Title, Date, Location etc) as used in faltering activities, and add it to the Histropedia database. The scanning program 76 also automatically downloads and analysis's successive Wikipedia data dumps, thereby keeping Histropedia and Wikipedia in data synchronism. It scans the whole of the Wikipedia data dump by accessing the most recent XML format ‘data dump’. The latest data dumps are downloaded as they are released (at least once a month). The scanning program 76 recognises all standard date formats that appear after the heading “date”, and also is operable to extract dates under different headings e.g. “Born”, “Died”, “constructed on”, “founded”, “Released”, and “Discovered”, to provide a non-exhaustive list. All extracted information is useable in filtering operations. The data is primarily extracted from the “infoboxes” in Wikipedia articles (these are the key information summary boxes that appear in many articles).

The overall software 74 also comprises a timeline assembly program 78 that, as earlier described with reference to FIG. 3, allows a user to create and store a custom timeline.

A Graphical User Interface (GUI) 80 allows the user 14, 16 to gain access to and control the other network server 12 programs 76, 78 as described. While it is preferred that the other network sever programs 76, 78 are contained nearly exclusively in the network server 12, especially in the case of portable user clients 16, the graphical user interface 80 can be provided in part on the user clients 14, 16 and in part on the network server 12 for the GUI 80 to co-operate between the user clients 14, 16 and the network server 12 to control the operations as described.

Attention is next drawn to FIG. 6, an exemplary screen layout of one possible GUI screen display suitable for use with the invention. A screen 82 comprises a display area 84 and a control selection area 86. The screen can have points and functions accessed by a conventional mouse-moved cursor. Alternatively, the screen 82 can be a touch screen. The selected position and action on the screen 82 can also be made using voice or pointer control.

The display area 84 is used to display and manipulate timeline elements. The control selection area 86 comprises selectable function areas 88 each of which can be selected to provide one or more successive drop down selection boxes. The control selection area 86 also comprises a typing area 90 wherein selections can be written to identify, for example, a subject area that the user wishes to select.

Timeline elements 92 are displayed in the display area 86 as a 3-D perspective, or, if available, as in some smart phones, an actual 3D display can be provided. In the example shown in FIG. 6, timelines 94 are shown as if on an axis going into the screen 82, and selected and filtered categories 96 are portrayed arranged side by side in a horizontal direction across the screen 82. It is to be appreciated that this represents one option only or the many display arrangement options available to the designer. Another option is, for example, that the timelines 94 should be provided on a horizontal axis. Another option, for example, is that some categories should be shown above or behind others.

Whatever display and control option is chosen by the designer, timelines 94 are both scrollable and zoomable with real-time rendering of events as they appear and disappear on the 94 timeline. Individual events can be removed, dragged and dropped to new 94 timelines or to other positions in a timeline 94 stack. A user can also add new material into the display to coincide with elements in the timeline 94 stack.

To summarize the general features described above, a data collection server 22 performs a database dump to a network server 12. The dumped database can provide some item identification data, such as place and date, but need not contain any. A scanning program 76 checks through the dumped database items seeking for other found identification information and saving that information with the database item in association with which it was discovered. This provides an improved database. A user can select one or more categories from the improved database and select filters to refine down what Items are displayed in a timeline 94. The user can manipulate, introduce and change items within a timeline to the user's choice. The user can communicate their selection to others.

The invention has been described with reference to the Wikipedia database. It is to be appreciated that the invention is applicable to any database where a copy of the database can be obtained.

It will be clear to the skilled man that many alternatives and modifications are possible without departing from the invention as claimed. The invention is more clearly defined by the Claims, appended here below.

1. A system operable to allow a user to access and filter a database, the system comprising:
communication means operable to receive a downloaded database dump from a data collection server;
scanning means operable to scan the downloaded database dump to discover and mark content falling into any one a plurality of filtering categories;
improved database storage means operable to store the marked database as an improved database;
user interface means operable to permit a user to access the improved database to obtain and display one or more subject categories on a timeline;
where
the user interface is operable to permit filtering of the displayed one or more subject categories.

2. The system according to claim 1 wherein the user interface is further operable to allow the user to perform at least one of: adding own items to a displayed timeline, removing items from a displayed timeline, scrolling a displayed timeline, and rearranging a displayed timeline.

3. The system, according to claim 1 wherein the subject categories include at least one of: subject title and place.

4. The system, according to claim 1, wherein the filtering categories include at least one of: subject matter, items containing copyright prohibited material, items containing copyright free material, items containing audio material, items containing photographic material, items containing video material, date of birth, date of death, date of construction, date of release, date of discovery, date of event, person's name, place of event, and place of image.

5. The system, according to claim 1, wherein the user interface is operable to permit the user to store a displayed assembly of data from the improved database.

6. The system, according to claim 5, wherein the user interface is operable to permit the user to send to others the displayed assembled data from the improved database.

7. The system, according to claim 1 wherein the database dump is a dump of the Wikipedia database.

8. A method for allowing a user to access and filter a database, the method comprising:
a step of receiving a downloaded database dump from a data collection server;
a step of scanning the downloaded database dump to discover and mark content falling into any one a plurality of filtering categories;
a step of storing the marked database as an improved database;
and
a step of permitting a user to access the improved database to obtain and display one or more subject categories on a timeline;
where
the a step of permitting a user to access the improved database includes a step of permitting the user to filter the displayed one or more subject categories.

9. The method, according to claim 8, including a step of permitting a user to perform at least one of: adding own items to a displayed timeline, removing items from a displayed timeline, scrolling a displayed timeline, and rearranging a displayed timeline.

10. The method, according to claim 8 wherein the subject categories include at least one of: subject title and place.

11. The method, according to any of claim 8 wherein the filtering categories include at least one of: subject matter, items containing copyright prohibited material, items containing copyright free material, items containing audio material, items containing photographic material, items containing video material, date of birth, date of death, date of construction, date of release, date of discovery, date of event, person's name, place of event, and place of image.

12. The method, according to any of claim 8 including a step of permitting the user to store a displayed assembly of data from the improved database.

13. The method, according to claim 12 including a step of permitting the user to send to others the displayed assembled data from the improved database.

14. The method, according to any of claims 8 wherein the database dump is a dump of the Wikipedia database.
